(19) United States
(12) Patent Application Publication
(10) Pub. No.: US 2022/0071169 A1
(43) Pub. Date: Mar. 10, 2022

(54) Pet Housing

(71) Applicant: Xiamen Sunnypet Products Co., Ltd., Xiamen, Fujian (CN)

(72) Inventor: Dirk Ralf Schumann, Münster (DE)

(73) Assignee: Xiamen Sunnypet Products Co., Ltd., Xiamen, Fujian (CN)

(21) Appl. No.: 17/414,273

(22) PCT Filed: May 9, 2019
(86) PCT No.: PCT/CN2019/086217

§ 371 Date: Jun. 15, 2021

(30) Foreign Application Priority Data
May 9, 2019 (CN) PCT/CN2019/086217

(51) Int. Cl. A01K 1/03

(52) U.S. Cl. CPC A01K 1/03

(57) ABSTRACT

Present invention teaches pet housing by putting together one or more unitary pieces; each unitary piece has two connector arms with a connector hole at the distal end, good for using a button connector to tie together. An inside liner is formed on each of the unitary piece; a padding is formed at the bottom of the housing form by the connected unitary pieces. The different angles of the connector arms to the connector strip will create an assembled pet housing with different visual effect, suitable for modern-day living inside people's houses.

### CLAIM OF PCT APPLICATION, 35 U.S.C. § 371

The present invention is a national stage entry from a PCT application, pursuant to the provision of 35 U.S.C. section 371 et seq., based upon the application filed by the same inventor in China, having PCT application number PCT/CN2019/086217 filed on May 9, 2019, which claims the priority filing date of Dec. 17, 2018 of Chinese Application No.: 201811543609.8.

### FIELD AND BACKGROUND OF THE INVENTION

Pets are becoming a regular part of people's lives. Pets provide more than physical assistance that were the main reason for their existence in the old days, such as hunting, home guarding and even blind-guiding. Pets provide emotional comfort to people just by being around.

Having pets around usually means the having the pet housing within people's living space, so that people can interact, touch, train and hold their pets without going out of their house. There are available indoor resting places, a housing of sort, commercially available. However, many of the available pet housing products are bulky, hard to transport or store away. For some pet housing products that can be said to be modern, multifunctional and portable, they tend to be quite expensive.

Present invention discloses and claims a pet housing that is versatile, easy to assemble and economically cost-effective. The pet housing of present invention further has an avant-garde style in the visual appeal that works well to go with modern dwelling and changing decorative styles enjoyed by people.

### SUMMARY OF THE INVENTION

The invention relates to a pet housing that can be easily assembled by putting together two or more unitary pieces together; a simplified version of using only one unitary piece folded up to form a pet housing is also introduced.

The unitary piece is made up by a substantially flat material, flexible and bendable for folding and connecting as discussed herein.

A first configuration of the unitary piece consists of a first connector arm and a second connector arm; a connector strip connects the two connector arms. A second configuration of the unitary piece has no connector strip, only the two connector arms.

When putting unitary pieces together to form a pet housing, they are tied together through the connector hole(s) via a fastener mechanism, the most common form would be using a connector button for inserting into the connector hole(s).

The two connector arms can be connected to the connector strip in 90-degree angle, acute angle, or obtuse angle fashions.

By folding the unitary pieces into a curvy or circular shape, using the fastener mechanism, tying the distal ends of the connector arms together, and inserting the connector button into the connector hole and forming into a spiral or curvy shape, a pet housing can be done easily. Inside lining and padding can be added to increase the comfort level for the pets.

The unitary piece can have a second configuration of either a rectangular piece or an arc-shaped piece, made from common flexible and bendable materials. This configuration has no connector strip between the two connector arms. The folding and tying mechanism is similar to the unitary piece of the first configuration.

A single unitary piece can also be made into a pet house, by connecting the distal ends of first connector arm and second connector arm, with a connector strip connecting the two connector arms

The pet housing of present invention essentially can be made by folding one or more unitary pieces, and connecting them together via the connector holes into a spiral or shape with an entrance made for the pets to go in and out.

When not in use, the pet housing of present invention can be easily disassembled and stored way in a way that takes up small space, suitable even for people that have the need to move from place to place due to work situation or other reasons.

### DESCRIPTION OF THE DRAWINGS

The accompanying drawings exemplify the preferred embodiments of the invention. Together with the description, serve to explain the principles of the invention.

A brief description of the drawings is as follows:

FIG. 1 shows the unitary piece of a preferred embodiment, with the connector arms being at a 90-degree angle to the connector strip.

FIG. 2 shows the pet housing by folding and connecting 3 unitary pieces together of the 90-degree angle embodiment.

FIG. 3 shows the unitary piece of another preferred embodiment, with the connector arms being at an acute angle to the connector strip.

FIG. 4 shows the pet housing by folding and connecting 3 unitary pieces together of the acute angle embodiment.

FIG. 5 shows the unitary piece of another preferred embodiment, with the connector arms being at an obtuse angle to the connector strip.

FIG. 6 shows the pet housing by folding and connecting 3 unitary pieces together of the obtuse angle embodiment.

FIG. 7 shows the unitary piece of the second configuration in an arc shape, without a connector strip.

FIG. 8 shows the pet housing by folding and connecting 3 arc-shaped unitary pieces together.

FIG. 9 shows the unitary piece of the second configuration in a rectangular shape, without a connector strip.

FIG. 10 shows the pet housing by folding and connecting 3 rectangle-shaped unitary pieces.

FIG. 11 shows the unitary piece of the second configuration in an arc shape, without a connector strip.

FIG. 12 shows a pet housing by folding and connecting 3 arc-shaped unitary pieces together.

FIG. 13 shows a pet housing by folding up a single unitary piece, with a connecter button tying up the two distal ends of the two connector arms.

### DETAILED DESCRIPTION OF THE PREFERRED EMBODIMENT

The pet housing of present invention is primarily composed of putting together one or more unitary pieces 10 together to form a pet housing.

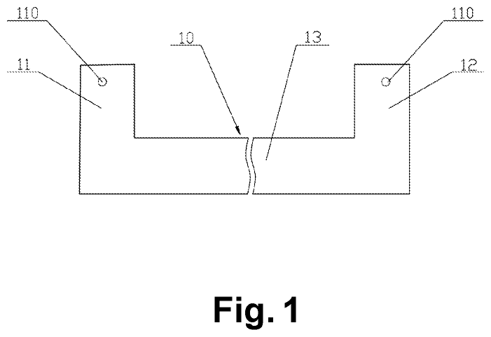

The unitary piece 10 is made up by a substantially flat material, consisting of a first connector arm 11 and a second connector arm 12; a connector strip 13 connects the two connector arms 11/12. This construction is shown in FIG. 1. The unitary piece 10 can be made of any flexible and bendable materials, including, but not limited to common HDPE, and LDPE materials.

At the distal end of each of the two connector arms 11/12, there is a connector hole 110, as shown in FIG. 1.

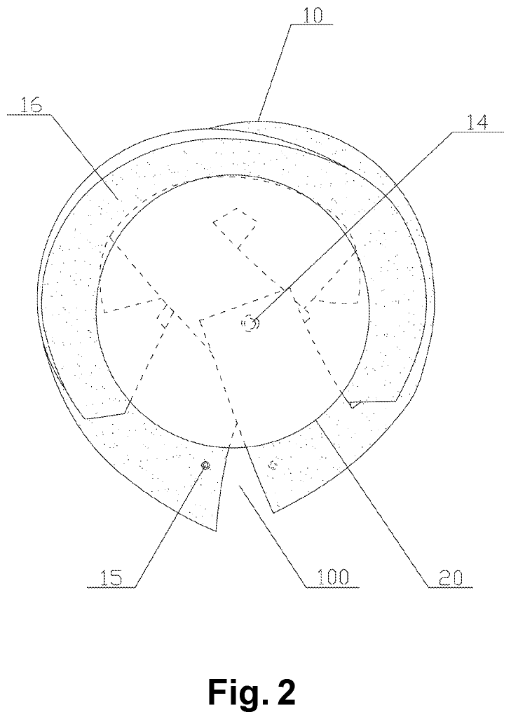

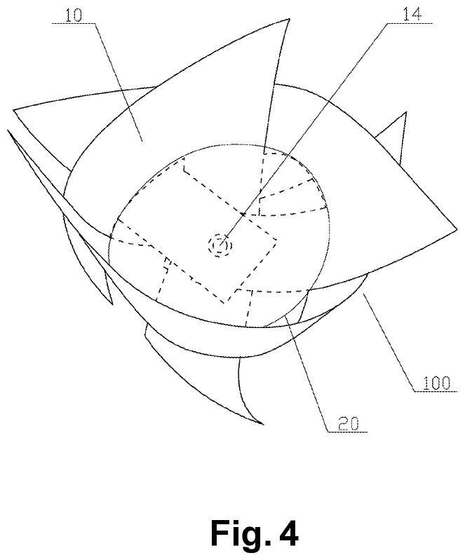

When putting at least 2 unitary pieces 10 together to form a pet housing, they are tied together via the connector hole 110 as shown in FIGS. 2 and 4, using a fastener mechanism 14.

The most common form of fastener mechanism is using a connector button 15 to insert into the connection holes 110 on the two connector arms 11 and 12 of the unitary pieces 10.

A layer of inside liner 16 is formed on each of the unitary piece 10, providing a softer contact area for the pets' comfort.

In a preferred embodiment, the two connector arms 11/12 are connected to the connector strip 13 in a 90-degree fashion, as shown in FIG. 1.

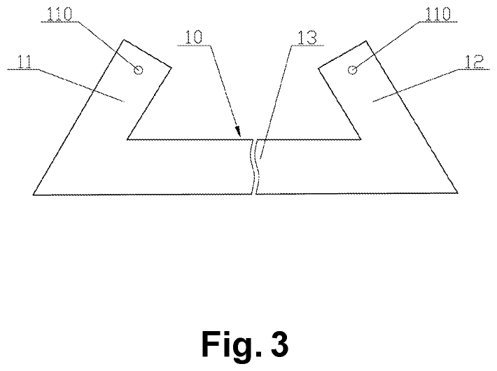

In yet another preferred embodiment, the two connector arms 11/12 are connected to the connecter strip 13 in an acute angle fashion, as shown in FIG. 3.

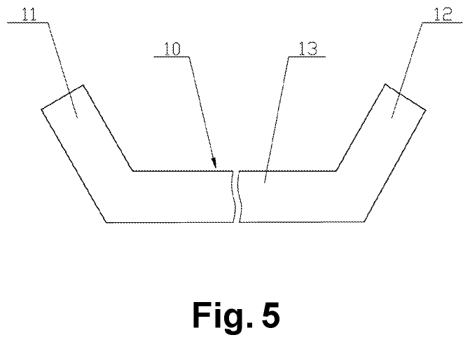

In yet another preferred embodiment, the two connector arms 11/12 are connected to the connector strip 13 in an obtuse angle fashion, as shown in FIG. 5.

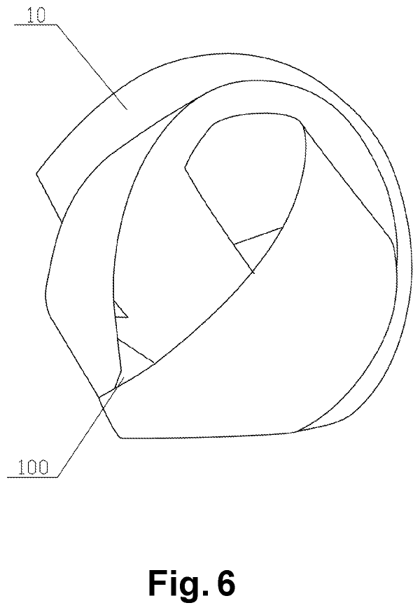

In the above embodiments stated above, as shown in FIGS. 1-6, the pet housing is formed by assembling 3 unitary pieces 10 together by folding the unitary pieces 10 into a curvy or circular shape, using the fastening mechanism 14, specifically the connector button 15 and the connector holes 110, to tie the distal ends of the connector arms 11/12 together into a spiral form, and leave an entrance 100 for pets to go in and out of the housing.

A padding 20 can be added to the bottom of the assembled pet housing, adding to the pets' comfort.

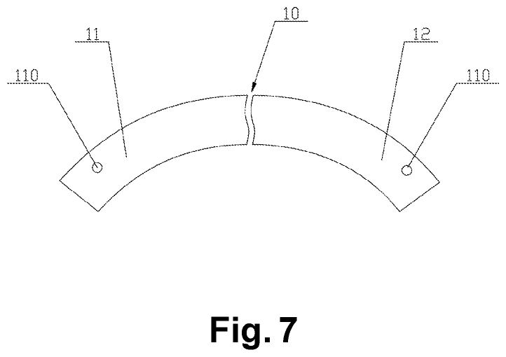

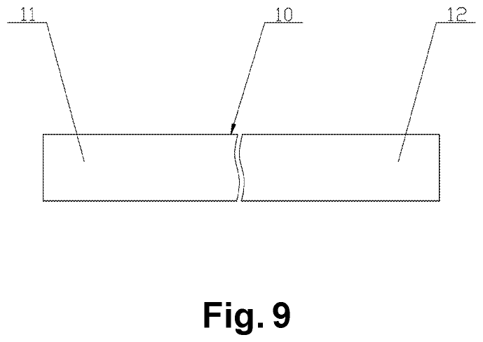

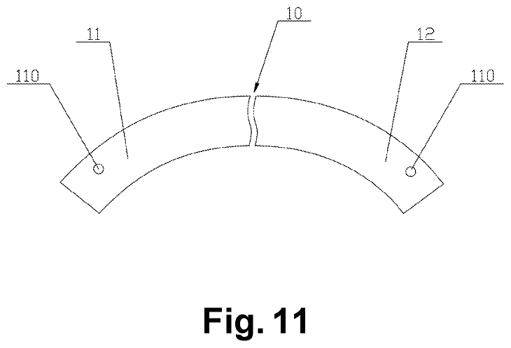

The unitary piece 10 can have a second configuration of either a rectangular piece or an arc-shaped piece, made from common flexible and bendable materials. This configuration has no connector strip 13 between the two connector arms 11/12. The rectangular unitary piece 10 is shown in FIG. 9; the arc-shaped unitary piece 10 is shown in FIGS. 7 and 11.

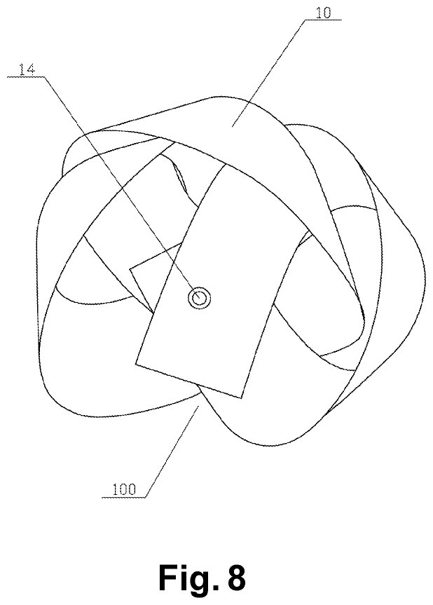

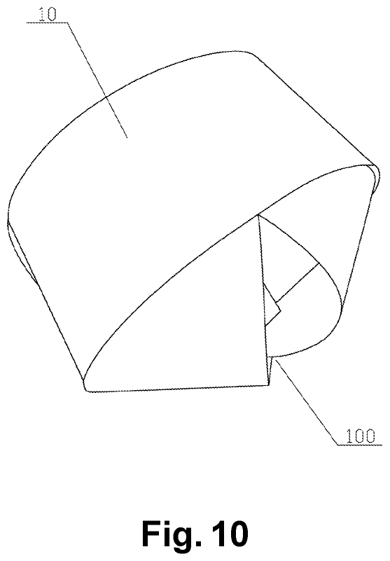

FIGS. 8, 10, and 12 show the pet housing by folding up at least 2 unitary pieces 10 (of the second configuration) and connecting them by a fastener mechanism 14 at distal ends of the two connector arms 11/12. The unitary pieces 10 of the second configuration also has a layer of inside liner 16. A layer of padding 20 can also be added to the folded up unitary pieces 10 to add to pets' comfort. An entrance 100 is made, as shown in FIG. 10.

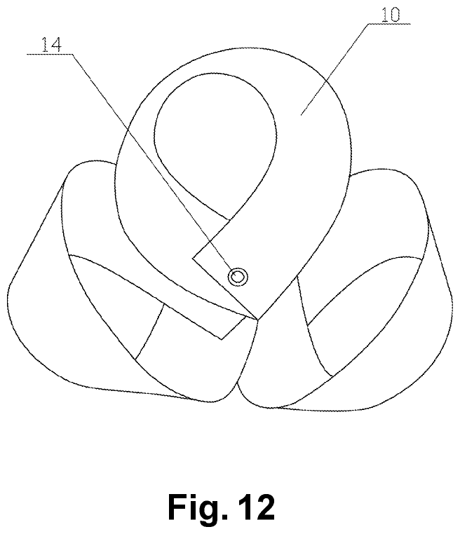

FIGS. 8 and 12 pet housing are both formed by folding and connecting 3 unitary pieces 10 of the arc-shaped configuration. The folding and connection styles between the two figures are different. FIG. 8 shows the unitary pieces 10 are interleaving together into a single spiral shape, whereas FIG. 12 shows the construction of 3 separate curved areas linked together by the connector holes 110 being fastened via a connector button 15.

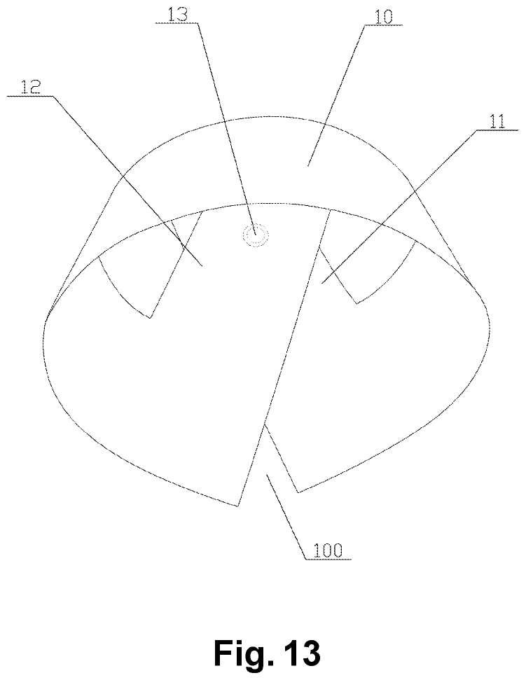

A different embodiment of pet housing can be made by using a single unitary piece 10 by connecting the distal ends of first connector arm 11 and second connector arm 12, with a connector strip 13 connecting the two connector arms, via a connector button 15 through connection holes 110, as shown in FIG. 13. An entrance is formed between the first connector arm 11 and the second connector arm 12.

The unitary piece 10 further has a layer of inside liner is formed on the unitary piece 10 for adding to the pets' comfort.

The pet housing of present invention essentially can be made by folding one or more unitary pieces 10, and connecting them together via the connector holes 110, into a spiral or shape with an entrance 100 made for the pets to go in and out. It should be noted that the description and disclosure made herein illustrated the preferred embodiments of the invention and are not meant to limit the scope of the applicant's rights. Variations and alterations may be employed for yet additional embodiments without departing from the scope of the invention herein.

1. A new pet house characterized by the following features: it comprises at least two blade unit bodies, each blade body is bent in an arc shape and features a first connection end and a second connection end, which partially overlap each other to give an arc-shaped enclosing wall with a through hole; and all arc-shaped enclosing walls are arranged at intervals along the same circumferential surface to form a house body, and the first connection ends and the second connection ends of all blade unit bodies are detachably fixed at the overlapping positions by means of connection members.

2. The said new pet house according to claim 1 is characterized by: the said blade unit body is made of elastic and bendable material, and the said blade unit body is in any one or more of U-shape, wavy shape, arc shape and long strip shape.

3. The said new pet house according to claim 1 is characterized by: the through holes of adjacent arc-shaped enclosing walls are arranged at intervals to form a spiral or approximately spiral house body.

4. The said new pet house according to claim 3 is characterized by: the two adjacent arc-shaped enclosing walls interpenetrated with each other are detachably connected.

5. The said new pet house according to claim 3 is characterized by: the new pet house is composed of three U-shaped blade unit bodies, the two vertical side walls on both sides of the said U-shaped blade unit bodies respectively form the first connection end and the second connection end, and the terminal of the first connection end and the terminal of the second connection end are fixed by a connection member.

6. The said new pet house according to claim 1 is characterized by: the two first connection ends and/or second connection ends on different ones of the said blade unit bodies form a pet doorway.

7. The said new pet house according to claim 6 is characterized by: the first connection end and/or the second connection end on both sides of the upper part of the said pet doorway are provided with mating connection buckles.

8. The said new pet house according to claim 1 is characterized by: the said connection member is any one of a connection buckle, a connection strip, and a connecting rod.

9. The said new pet house according to claim 1 is characterized by: the bottom of the said house body is provided with a pet pad.

10. The said new pet house according to claim 1 is characterized by: the inner wall of each blade unit body is provided with an inner interlayer made of soft material.

11. A new pet house which is characterized by the following features: it comprises a blade unit body, which features a first connection end and a second connection end and is bent in an arc-shape to form a house body, and the said first connection end and the second connection end are detachably connected.
